(19) United States
(12) Patent Application Publication
(10) Pub. No.: US 2024/0358480 A1
(43) Pub. Date: Oct. 31, 2024

(54) MULTI-SEGMENT DENTAL IMPLANT

(71) Applicants: Jason Tubo, Wellesley, MA (US); Yoan Raimondo, Wellesley, MA (US)

(72) Inventors: Jason Tubo, Wellesley, MA (US); Yoan Raimondo, Wellesley, MA (US)

(21) Appl. No.: 18/138,845

(22) Filed: Apr. 25, 2023

(51) Int. Cl. A61C 8/00

(52) U.S. Cl. CPC A61C 8/0037; A61C 8/0022; A61C 8/0068; A61C 8/0074

(57) ABSTRACT

A multi-segment dental implant may include an apical segment including apical external threading at least partially surrounding the apical segment, wherein the apical segment defines a connection aperture including an coronal shoulder. The multi-segment dental implant may include a coronal segment including coronal external threading at least partially surrounding the coronal segment and terminating in a non-knife-edge apical skirt. The multi-segment dental implant may include a connector constructed and arranged to connect the apical segment and the coronal segment.

### TECHNICAL FIELD

The embodiments generally relate to endosteal (or in-bone) dental implants.

### BACKGROUND

Endosteal dental implants are typically categorized as tissue-level or bone-level implants. Both tissue-level and bone-level endosteal implants are engineered to contact and thus integrate with bone at that specific minimum level.

Dental implants may be considered too shallow with respect to implant location or position due to progressive loss of bone surrounding the implant from injury or disease, improper initial placement of the implant, or if there is a change in the intended restorative use of the implant.

Dental implants that are insufficiently surrounded by bone may result in exposure of the threads to the oral bacterial environment, weakened or total loss of attached soft tissue, accelerated bone loss, visible prosthetic margins, unhygienic debris traps, and speech or esthetic problems due to prosthesis air gaps.

Dental implants that have experienced bone loss, or that exhibit exposed threads may require removal of the implant and re-implantation of a new implant at a deeper level within the bone. Alternatively, the implant threads may be machined or polished to create more hygienic, smoother surfaces. Machining may improve the hygienic qualities of the dental implant, however the prosthetic platform remains unchanged, in a non-ideal position.

Even when completely surrounded by bone, some dental implants may be judged too shallow prosthetically, leaving inadequate restorative clearance (which is the space required to appropriately house the components of the prothesis). Dental implants may be considered prosthetically shallow if a natural emergence profile cannot be formed, or if an abutment margin is visible, or if a prosthesis transition line is visible. Both the issues of inadequate restorative clearance, or a visible transition line may be managed by creating a non-hygienic “ridge-lap” flange on the bridge. A “ridge-lap” by definition is concave on the tissue-contacting (intaglio) surface of the bridge; which may trap food or bacteria resulting in chronic inflammation and potentially infection and loss of implants; Alternatively, implant or implants that are too prosthetically shallow may be invasively removed, bone grafted, and new implant or implants placed to a deeper level within the bone.

Transition lines may be unintentionally visible when implants are positioned too prosthetically shallow and the line between an implant bridge or full arch implant prosthetic and the natural gum tissue is seen during normal facial expressions such as laughing or smiling. Visible transition lines may be managed by creating a non-hygienic “ridge-lap” flange on the bridge which may trap food or bacteria resulting in loss of implants; using botulinum toxin at the lip muscles to hide the transition line; removing the bridge and having the patient wear a removable denture that may or may not attach to the implants; or invasive removal of the implants and placing new implants with prosthetic platforms at a deeper level.

Often, dental implants may replace a single tooth. If additional teeth or an arch of teeth require replacement in the future, it may be desirable to repurpose existing single tooth implants to assist with stabilization of the bridge. Single tooth implants are often placed at a more shallow prosthetic depth than an implant intended for a multi-tooth bridge or full arch prosthesis. Implants reutilized in a bridge prosthesis often encounter problems as above with visible transition lines, past or progressing bone loss, and inadequate restorative clearance requiring interventions mentioned previously, or invasive removal.

### SUMMARY OF THE INVENTION

This summary is provided to introduce a variety of concepts in a simplified form that is disclosed further in the detailed description of the embodiments. This summary is not intended to identify key or essential inventive concepts of the claimed subject matter, nor is it intended for determining the scope of the claimed subject matter.

The embodiments described herein disclose a multi-segment dental implant that may include an apical segment including apical external threading at least partially surrounding the apical segment, wherein the apical segment defines a connection aperture including an coronal shoulder. The multi-segment dental implant may include a coronal segment, or plurality of coronal segments, each including coronal external threading at least partially surrounding the coronal segment which may terminate at the apical end of the segment with threads that continue onto the next segment, or in a non-knife-edge apical skirt. The multi-segment dental implant may include a connector constructed and arranged to connect the apical segment and the coronal segment. Multiple coronal segments may be connected to one another and an apical segment, and may be subsequently removed after osseointegration with local bone removal.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a perspective view of a multi-segment dental implant, according to some embodiments;

FIG. 2A illustrates a perspective view of a multi-segment dental implant, according to some embodiments;

FIG. 2B illustrates a cross-sectional view of a multi-segment dental implant, according to some embodiments;

FIG. 3A illustrates a perspective view of a multi-segment dental implant, according to some embodiments;

FIG. 3B illustrates a cross-sectional view of a multi-segment dental implant, according to some embodiments;

FIG. 4A illustrates a cross-sectional view of a multi-segment dental implant, according to some embodiments;

FIG. 4B illustrates a cross-sectional view of a multi-segment dental implant, according to some embodiments;

FIG. 5A illustrates a perspective view of a multi-segment dental implant, according to some embodiments; and

FIG. 5B illustrates a cross-sectional view of a multi-segment dental implant, according to some embodiments; and

FIG. 6 illustrates a cross-sectional view of a multi-segment dental implant, according to some embodiments.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described apparatus. Any specific details of the embodiments are used for demonstration purposes only, and no unnecessary limitations or inferences are to be understood therefrom.

Before describing in detail exemplary embodiments, it is noted that the embodiments reside primarily in combinations of components and procedures related to the apparatus. Accordingly, the apparatus components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

The specific details of the single embodiment or variety of embodiments described herein are set forth in this application. Any specific details of the embodiments are used for demonstration purposes only, and no unnecessary limitation or inferences are to be understood therefrom. Furthermore, as used herein, relational terms, such as “first” and “second,” “top” and “bottom,” and the like, may be used to distinguish one entity or element from another entity or element without necessarily requiring or implying any physical or logical relationship, or order between such entities or elements.

In general, the embodiments relate to a multi-segment dental implant that may be joined together and surgically placed as a single dental implant. All segments and components of the assembled implant apparatus are intended to osseointegrate with local bone tissue. The end of the device, or segment, that is intended to be nearest to the teeth is the coronal end; the end deepest in the bone is called the apical end. Each segment of the implant assembly has a coronal and apical orientation. Each segment has a prosthetic connection at its coronal end. In any segment other than the apical segment, a connection apparatus is present on the apical aspect allowing for precise connection to the next most apical segment.

The coronal segment of a multi-segment dental implant may have a tissue level or bone level prosthetic connection. All segments other than the coronal segment may have bone level prosthetic connections. The implant can be designed to have identical prosthetic connections at each segment or can be designed with prosthetic connections of non-matching size, for example, to accommodate a tapered implant design in an apical segment.

The implant apparatus can be designed with threads including various coatings, shapes, or pitch. An apical skirt may assist with identifying the end of a segment, as well as create a solid region to terminate implant threads. The segments can be designed to engage with each other and stop at a maximum torque, even if the implant apparatus was driven through very dense bone, allowing for a coronal body to be disengaged without exceeding usual prosthetic torque levels.

According to one embodiment, a two-piece dental implant may include a coronal segment and an apical segment.

According to one embodiment, a three-piece may include a coronal segment, a mid-segment, and an apical segment.

According to one embodiment, a four-or-more-piece may include a coronal segment, multiple mid-segments, and an apical segment.

According to some embodiments, a multi-segment dental implant may include multiple segments which exhibit identical prosthetic connections from one segment to the next. Adjacent segments may be connected via solid friction-fitting connection which bypasses the prosthetic connection of the more apical segment and engages below it, leaving the prosthetic connection in a virgin state.

In practice and in use, where a deeper prosthetic platform is desirable, whether due to bone loss, or inadequate prosthetic planning, or because of a change in prosthetic intention, a coronal segment can be removed revealing a new prosthetic connection at a deeper level than the original prosthetic connection. Removal of the coronal segment may or may not require removal of bone via trephination to allow loosening and disengagement of the coronal segment from the apical segment(s). The new deeper prosthetic connection will allow for increased restorative clearance, better camouflage of transition lines, or elimination of peri-implant disease tissue via tabling of bone to the new deeper fixture level.

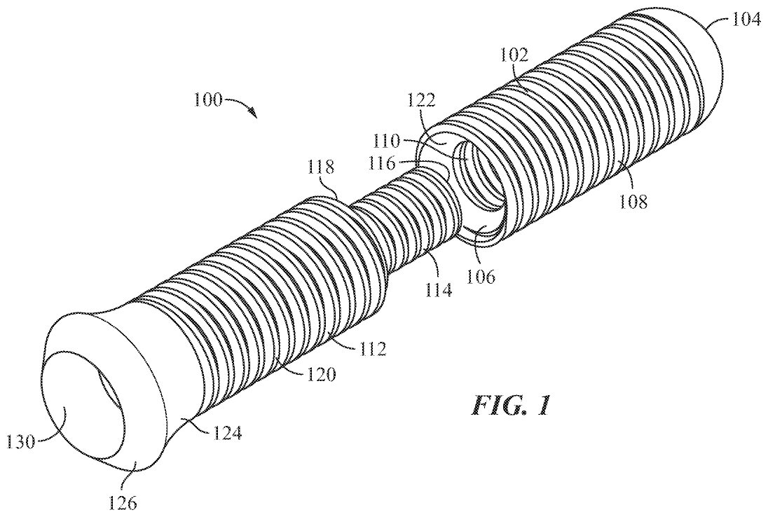

FIG. 1 illustrates a perspective view of a multi-segment dental implant 100 including an apical segment 102 having an apical end 104. Apical external threading 108 may at least partially thread around the apical segment 102. The apical segment may define a connection aperture 122 including internal threading 110 and an apical shoulder seat 106, which may both receive and threadingly engage with a connector 116, connection threading 114, and apical end shoulder 118 of the coronal segment 112.

The coronal segment 112 may include coronal external threading 120 threadingly surrounding at least a portion of the coronal segment 112. The coronal segment may include a tissue-level prosthetic connection 130 at the coronal end, a coronal end shoulder 126, and polished tissue collar 124.

As seen in FIG. 1, the apical shoulder seat 106 and apical end shoulder 118 may both be generally conical in shape, or generally truncated cone in shape, and may be complimentary to one another to facilitate uniform contact between the two when the apical segment 102 is attached to the coronal segment 112 such that the apical shoulder and apical end shoulder 118 abut one another.

FIG. 1 depicts a connector 116 as a mechanically threading neck and connection aperture 122 but, as will be understood from the entirety of this disclosure, the connector 116 and connection aperture 122 may take a variety of forms and arrangements.

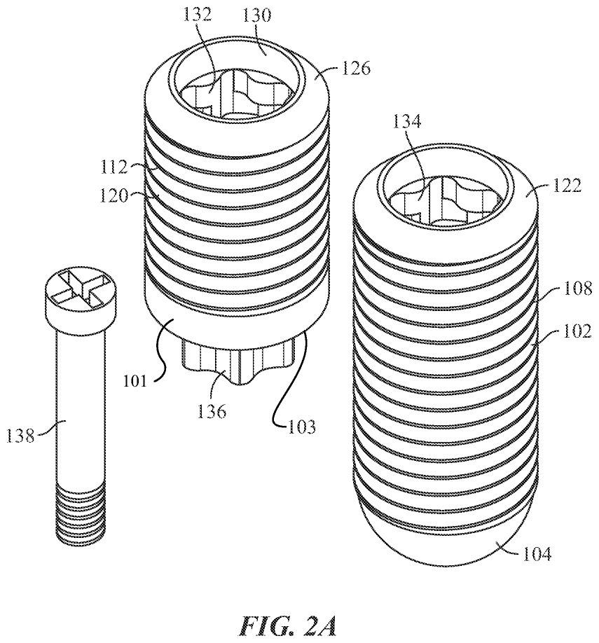

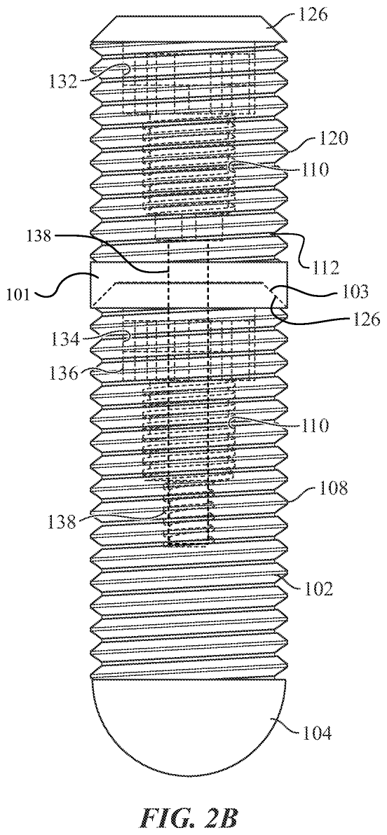

FIG. 2A illustrates a perspective view of a multi-segment dental implant including an apical segment 102 having an apical end 104. Apical external threading 108 may at least partially thread around the apical segment 102. The apical segment 102 may define a connection fixture aperture 134 including a coronal shoulder 122, which may both receive and mechanically engage with a connection fixture 136 and screw 138, which may threadingly connect the apical segment 102 and coronal segment 112.

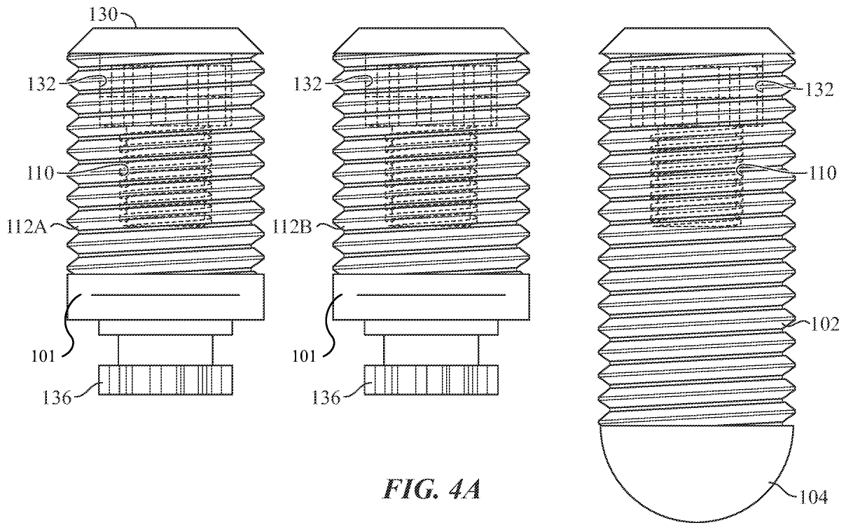

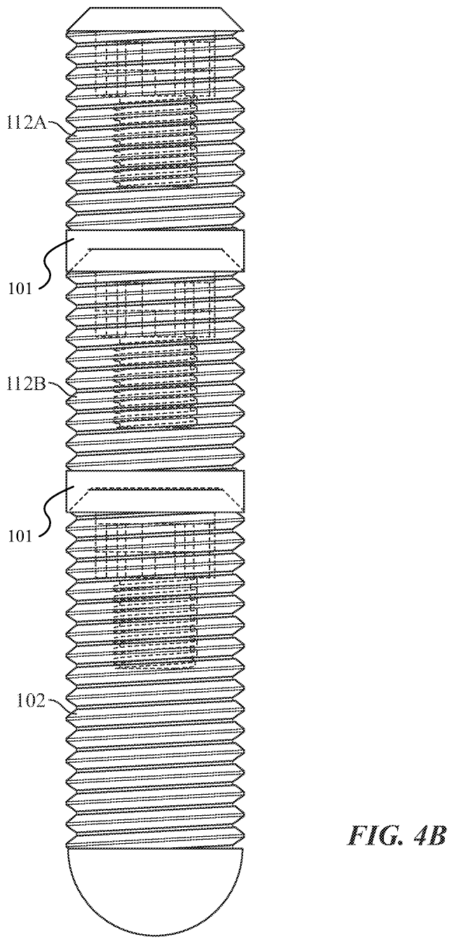

The coronal segment 112 may include coronal external threading 120 threadingly surrounding at least a portion of the coronal segment 112 ending in a coronal shoulder seat 103 and an apical skirt 101 which prevents the apical external threading 120 from terminating into a knife-edge segment. The apical skirt 101 may also assist with the removal of a coronal segment 112 after osseointegration. The coronal segment may include a coronal end 130 defining a connection fixture aperture 132, and coronal shoulder 126. The coronal end 130, connection fixture aperture 132, and coronal shoulder 126 may be constructed and arranged to mechanically engage with a second coronal segment, depicted in FIGS. 4A and 4B.

The connection fixture aperture 132/134 and connection fixture 136 may be constructed and arranged to mechanically engage with one another to temporarily or permanently lock segments together.

FIG. 2B illustrates a cross sectional view of a multi-segment dental implant including an apical segment 102 having an apical end 104. Apical external threading 108 may at least partially thread around the apical segment 102. The apical segment 102 may define a connection fixture aperture 134, which may both receive and mechanically engage with a connection fixture 136 and screw 138, which may threadingly connect the internal threading 110 of the apical segment 102 and coronal segment 112.

The coronal segment 112 may include coronal external threading 120 threadingly surrounding at least a portion of the coronal segment 112 ending in an apical skirt 101 which prevents the apical external threading 108 from terminating into a knife-edge segment. The apical skirt 101 may also assist with the removal of a coronal segment 112 after osseointegration. The coronal segment may include a coronal end 130 defining a connection fixture aperture 132 and coronal shoulder 126. The coronal end 130, connection fixture aperture 132, and coronal shoulder 126 may be constructed and arranged to mechanically engage with a second or third, depicted in FIGS. 4A and 4B, or a fourth or more coronal segments.

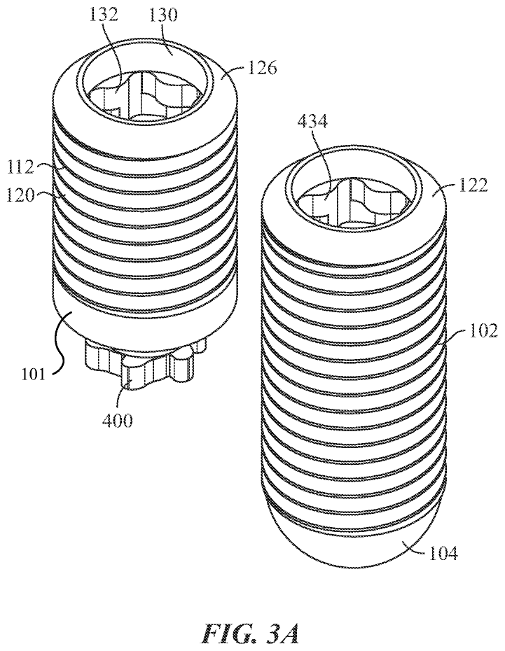

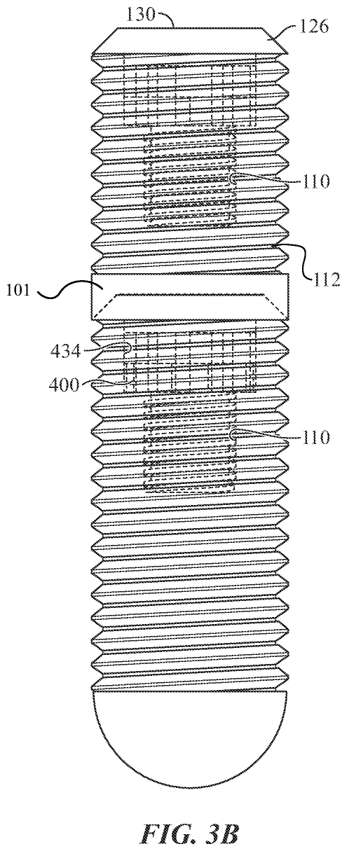

FIGS. 3A and 3B illustrate a perspective view and cross-sectional view, respectively, of a screw-less multi-segment dental implant including an apical segment 102 having an apical end 104. Apical external threading 108 may at least partially thread around the apical segment 102. The apical segment 102 may define a connection aperture 434 including a coronal shoulder 122, which may both receive and mechanically engage with a connection fixture 400, which may mechanically connect the apical segment 102 and coronal segment 112 by attaching the connection fixture 400 into the connection aperture 434.

The coronal segment 112 may include coronal external threading 120 threadingly surrounding at least a portion of the coronal segment 112 ending in an apical skirt 101 which prevents the apical external threading 108 from terminating into a knife-edge segment. The apical skirt 101 may also assist with the removal of a coronal segment 112 after osseointegration. The coronal segment may include a coronal end 130 defining a connection fixture aperture 132 and coronal shoulder 126. The coronal end 130, connection fixture aperture 132, and coronal shoulder 126 may be constructed and arranged to mechanically engage with a second coronal segment, such as via the connection fixture 400, depicted in FIGS. 4A and 4B.

FIGS. 4A and 4B illustrate a perspective view and cross sectional view, respectively, of a screw-less multi-segment dental implant including an apical segment 102 having an apical end 104. The screw-less multi-segment dental implant may include a plurality of coronal segments 112A, 112B which may temporarily or permanently connect with one another and the apical segment 102.

Apical external threading 108 may at least partially thread around the apical segment 102. The apical segment 102 may define a connection aperture 434 including an coronal shoulder 122, which may both receive and mechanically engage with a connection fixture 400, which may mechanically connect the apical segment 102 and coronal segment 112 by attaching the connection fixture 400 into the connection aperture 434.

The coronal segments 112A, 112B may include coronal external threading 120 threadingly surrounding at least a portion of the coronal segment 112 ending in an apical skirt 101 which prevents the apical threading 108 from terminating into a knife-edge segment. The coronal segments 112A, 112B may include a coronal end 130 defining a connection fixture aperture 132 and coronal shoulder 126. The coronal end 130, connection fixture aperture 132, and coronal shoulder 126 may be constructed and arranged to mechanically engage with a second coronal segment 112A, 112B.

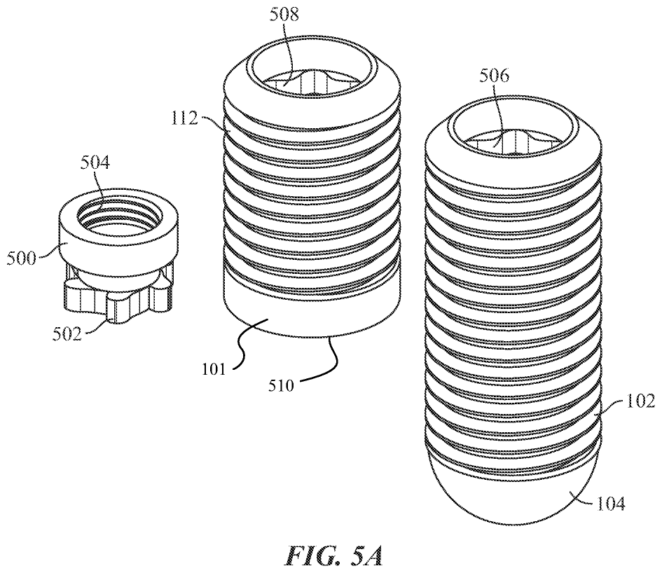

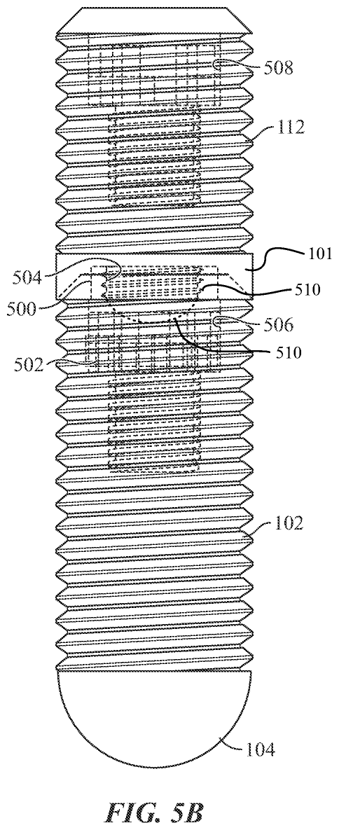

FIGS. 5A and 5B illustrate a perspective view and cross-sectional view, respectively, of a multi-segment dental implant including an apical segment 102 and coronal segment 112, which may be temporarily or permanently joined to one another via connector 500 attached to a connector ferrule 510 and a connection aperture 506. The apical segment 102 may include an apical end 104 opposite a connection aperture 506 constructed and arranged to mechanically engage with a connection fixture 502 of the connector 500.

The connector 500 may define a threaded connector receiver 504 configured to join the apical segment 102 and the coronal segment 112.

The coronal segment 112 may define connection fixture aperture 508 constructed and arranged to mechanically engage with a connection fixture 502 of the connector 500, such that an a second coronal segment may be attached to a first coronal segment.

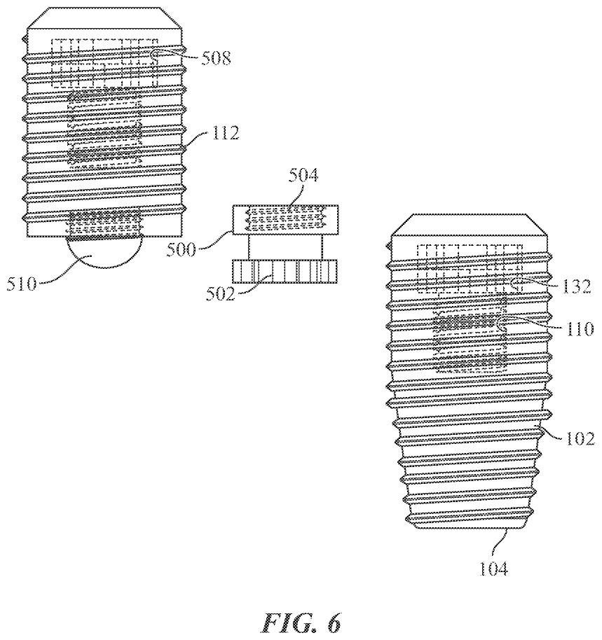

FIG. 6 illustrates a cross-sectional view of a multi-segment dental implant including an tapered apical segment 102 and coronal segment 112, which may be temporarily or permanently joined to one another via connector 500 attached to a connector ferrule 510 and a connection aperture 506. The apical segment 102 may include an apical end 104 opposite a connection aperture 506 constructed and arranged to mechanically engage with a connection fixture 502 of the connector 500.

The connector 500 may define a threaded connector receiver 504 configured to join the apical segment 102 and the coronal segment 112 via connector ferrule 510.

The coronal segment 112 may define connection fixture aperture 508 constructed and arranged to mechanically engage with a connection fixture 502 of the connector 500, such that an a second coronal segment may be attached to a first coronal segment.

The following description of variants is only illustrative of components, elements, acts, products, and methods considered to be within the scope of the invention and are not in any way intended to limit such scope by what is specifically disclosed or not expressly set forth. The components, elements, acts, products, and methods as described herein may be combined and rearranged other than as expressly described herein and are still considered to be within the scope of the invention.

According to variation 1, a multi-segment dental implant may include an apical segment including an apical end and apical external threading at least partially surrounding the apical segment, wherein the apical segment defines a connection aperture including internal threading and an apical shoulder seat; and at least one coronal segment including coronal external threading at least partially surrounding the coronal segment and terminating in an apical skirt, the coronal segment further including a coronal end, an apical end shoulder, and a connector constructed and arranged to connect to the connection aperture.

Variation 2 may include multi-segment dental implant as in variation 1, wherein the apical shoulder seat and the apical end shoulder may both be generally conical in shape.

Variation 3 may include multi-segment dental implant as in variation 1 or 2, wherein the apical shoulder seat and the apical end shoulder include complimentary profiles relative to one another to facilitate substantially uniform contact when the apical segment is attached to the at least one coronal segment.

Variation 4 may include multi-segment dental implant as in any of variations 1 through 3, wherein the apical shoulder seat and the apical end shoulder include complimentary profiles relative to one another such that an apical shoulder seat and apical end shoulder abut one another when the apical segment is attached to at least one coronal segment.

Variation 5 may include multi-segment dental implant as in any of variations 1 through 4, wherein the apical external threading does not terminate at a knife-edge segment.

Variation 6 may include multi-segment dental implant as in any of variations 1 through 5, wherein the apical skirt is constructed and arranged to facilitate removal of a coronal segment after osseointegration.

Variation 7 may include multi-segment dental implant as in any of variations 1 through 6, wherein the coronal end includes a prosthetic connection.

Variation 8 may include multi-segment dental implant as in any of variations 1 through 7, wherein the connector is a screw.

According to variation 9, a multi-segment dental implant may include an apical segment including an apical end and apical external threading at least partially surrounding the apical segment, wherein the apical segment defines a connection aperture including a coronal shoulder; at least one coronal segment including coronal external threading at least partially surrounding the coronal segment and terminating in an apical skirt, the coronal segment further including a coronal end, a coronal shoulder; and a connector affixed to the at least one coronal segment, the connector being constructed and arranged to connect to the connection aperture, wherein the connector and the connection aperture include complimentary profiles relative to one another to facilitate substantially uniform contact between the coronal shoulder seat and the coronal shoulder.

Variation 10 may include multi-segment dental implant as in variation 9, wherein the at least one coronal segment is a plurality of coronal segments.

Variation 11 may include multi-segment dental implant as in variation 9 or 10, wherein the coronal shoulder seat and the coronal shoulder may both be generally truncated conical in shape.

Variation 12 may include multi-segment dental implant as in any of variations 9 through 11, wherein the coronal shoulder seat and the coronal shoulder include complimentary profiles relative to one another such that an coronal shoulder seat and coronal shoulder abut one another when the apical segment is attached to the at least one coronal segment.

Variation 13 may include multi-segment dental implant as in any of variations 9 through 12, wherein the apical external threading does not terminate at an approximate knife-edge.

Variation 14 may include multi-segment dental implant as in any of variations 9 through 13, wherein the apical skirt is constructed and arranged to facilitate removal of a coronal segment after osseointegration.

Variation 15 may include multi-segment dental implant as in any of variations 9 through 14, wherein the coronal end includes a prosthetic connection.

Variation 16 may include multi-segment dental implant as in any of variations 9 through 15, wherein the connector is approximately star-shaped.

According to variation 17, a screw-less multi-segment dental implant may include an apical segment including an apical end and apical external threading at least partially surrounding the apical segment, wherein the apical segment defines a connection aperture including an coronal shoulder; at least one coronal segment including coronal external threading at least partially surrounding the coronal segment and terminating in an apical skirt, the coronal segment further including a coronal end, a coronal shoulder; and a connector with the connector being constructed and arranged to connect to the connection aperture of the apical segment and the at least one coronal segment, wherein the connector and the connection aperture include complimentary profiles relative to one another to facilitate substantially uniform contact between the coronal shoulder seat and the coronal shoulder.

Variation 18 may include a multi-segment dental implant as in variation 17, wherein the connector threadingly attaches to the coronal segment approximately near the apical skirt.

Variation 19 may include a multi-segment dental implant as in variation 17 or 18, wherein the coronal shoulder is approximately a truncated cone in shape.

Variation 20 may include a multi-segment dental implant as in variations 17, 18, or 19 wherein the apical segment is tapered.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the

What is claimed is:

1. A multi-segment dental implant comprising:
an apical segment comprising an apical end and apical external threading at least partially surrounding the apical segment, wherein the apical segment defines a connection aperture comprising internal threading and an apical shoulder seat; and
at least one coronal segment comprising coronal external threading at least partially surrounding the coronal segment and terminating in an apical skirt, the coronal segment further comprising a coronal end, a coronal end shoulder, and an apical end shoulder and connector constructed and arranged to connect to the connection aperture.

2. A multi-segment dental implant as in claim 1, wherein the apical shoulder seat and the apical end shoulder may both be generally conical in shape.

3. A multi-segment dental implant as in claim 1, wherein the apical shoulder seat and the apical end shoulder comprise complimentary profiles relative to one another to facilitate substantially uniform contact when the apical segment is attached to the at least one coronal segment.

4. A multi-segment dental implant as in claim 1, wherein the apical shoulder seat and the apical end shoulder comprise complimentary profiles relative to one another such that an apical end seat and apical end shoulder abut one another when the apical segment is attached to the at least one coronal segment.

5. A multi-segment dental implant as in claim 1, wherein the coronal external threading of a coronal segment does not terminate at a knife-edge segment.

6. A multi-segment dental implant as in claim 1, wherein the apical skirt is constructed and arranged to facilitate removal of a coronal segment after osseointegration.

7. A multi-segment dental implant as in claim 1, wherein the coronal end comprises a tissue-level prosthetic connection.

8. A multi-segment dental implant as in claim 1, wherein the connector is a screw.

9. A multi-segment dental implant comprising:
an apical segment comprising an apical end and apical external threading at least partially surrounding the apical segment, wherein the apical segment defines a connection fixture aperture comprising a coronal shoulder;
at least one coronal segment comprising coronal external threading at least partially surrounding the coronal segment and terminating in an apical skirt, the coronal segment further comprising a coronal end, a coronal shoulder; and
a connector affixed to the at least one coronal segment, the connector being constructed and arranged to connect to the connection fixture aperture, wherein the connector and the connection fixture aperture comprise complimentary profiles relative to one another to facilitate substantially uniform contact between the coronal shoulder seat and the coronal shoulder.

10. A multi-segment dental implant as in claim 9, wherein the at least one coronal segment is a plurality of coronal segments.

11. A multi-segment dental implant as in claim 10, wherein the coronal shoulder seat and the coronal shoulder may both be generally truncated conical in shape.

12. A multi-segment dental implant as in claim 10, wherein the coronal shoulder seat and the coronal shoulder comprise complimentary profiles relative to one another such that a coronal shoulder seat and coronal shoulder abut one another when the apical segment is attached to the at least one coronal segment.

13. A multi-segment dental implant as in claim 10, wherein the apical external threading does not terminate at an approximate knife-edge.

14. A multi-segment dental implant as in claim 10, wherein the apical skirt is constructed and arranged to facilitate removal of a coronal segment after osseointegration.

15. A multi-segment dental implant as in claim 10, wherein the coronal end comprises a prosthetic connection.

16. A multi-segment dental implant as in claim 10, wherein the connector is approximately star-shaped.

17. A screw-less multi-segment dental implant comprising:
an apical segment comprising an apical end and apical external threading at least partially surrounding the apical segment, wherein the apical segment defines a connection fixture aperture comprising a coronal shoulder;
at least one coronal segment comprising coronal external threading at least partially surrounding the coronal segment and terminating in an apical skirt, the coronal segment further comprising a coronal end, a coronal shoulder; and
a connector; the connector being constructed and arranged to connect to the connection fixture aperture of the apical segment and the at least one coronal segment, wherein the connector and the connection aperture comprise complimentary profiles relative to one another to facilitate substantially uniform contact between the coronal shoulder seat and the coronal shoulder.

18. A multi-segment dental implant as in claim 17, wherein the connector threadingly attaches to the coronal segment approximately near the apical skirt.

19. A multi-segment dental implant as in claim 17, wherein the coronal shoulder is approximately a truncated cone in shape.

20. A multi-segment dental implant as in claim 17, wherein the apical segment is tapered.
